(19) United States
(12) Patent Application Publication
(10) Pub. No.: US 2026/0172694 A1
(43) Pub. Date: Jun. 18, 2026

(54) PROCESSING METHODS, APPARATUS, AND ELECTRONIC DEVICE

(71) Applicant: Lenovo (Beijing) Limited, Beijing (CN)

(72) Inventors: Zhuoran XU, Beijing (CN); Zhichao CHEN, Beijing (CN); Shanghui ZHANG, Beijing (CN)

(21) Appl. No.: 19/536,140

(22) Filed: Feb. 10, 2026

Related U.S. Application Data
(63) Continuation of application No. PCT/CN2024/098579, filed on Jun. 12, 2024.

(30) Foreign Application Priority Data
Aug. 23, 2023 (CN) 202311068731.5

(51) Int. Cl. H04N 23/72; H04N 23/667; H04N 23/741; H04N 23/80

(52) U.S. Cl. CPC H04N 23/72; H04N 23/667; H04N 23/741; H04N 23/80

(57) ABSTRACT

A processing method includes activating an image acquisition apparatus configured to sense ambient light to generate captured images, and continuously storing M photos in response to a target instruction. The M photos are generated by fusing the captured images, and M is a positive integer greater than or equal to 2.

### CROSS-REFERENCE TO RELATED APPLICATIONS

This application is a continuation of International Application No. PCT/CN2024/098579, filed on Jun. 12, 2024, which claims priority to Chinese Application No. 202311068731.5, filed Aug. 23, 2023, the entire contents of both of which are incorporated herein by reference.

### TECHNICAL FIELD

The present disclosure generally relates to the field of image processing, and, more particularly, to a processing method, an apparatus, and an electronic device.

### BACKGROUND

Image acquisition apparatus are important modules of smart devices (such as mobile phones, cameras, camcorders, etc.). In a special mode, a specified number of images need to be collected and a photo generated before the shutter can be triggered to capture a second photo. When a user needs to continuously take multiple photos, there is a delay each time the shutter is triggered while the image acquisition apparatus collects the images, resulting in a longer shooting delay and a poor user experience.

### SUMMARY

In accordance with the disclosure, there is provided a processing method including activating an image acquisition apparatus configured to sense ambient light to generate captured images, and continuously storing M photos in response to a target instruction. The M photos are generated by fusing the captured images, and M is a positive integer greater than or equal to 2.

Also in accordance with the disclosure, there is provided an electronic device including a bus, a processor, and a memory connected to the processor through the bus, and storing an application program that, when executed by the processor, causes the electronic device to activate an image acquisition apparatus configured to sense ambient light to generate captured images, and continuously store M photos in response to a target instruction. The M photos are generated by fusing the captured images, and M is a positive integer greater than or equal to 2.

Also in accordance with the disclosure, there is provided non-transitory computer-readable storage medium storing an application program that, when executed by a processor, causes an electronic device including the processor to activate an image acquisition apparatus configured to sense ambient light to generate captured images, and continuously store M photos in response to a target instruction. The M photos are generated by fusing the captured images, and M is a positive integer greater than or equal to 2.

### BRIEF DESCRIPTION OF THE DRAWINGS

To more clearly illustrate the technical solutions in the embodiments of the present disclosure, the drawings for the description of the embodiments are briefly introduced below. Obviously, the drawings in the following description are only some embodiments of the present disclosure, and those skilled in the art can obtain other drawings based on the present disclosure without creative effort.

FIG. 1 is a schematic flowchart of a processing method consistent with the present disclosure.

FIG. 2 is a schematic flowchart of another processing method consistent with the present disclosure.

FIG. 3 is a schematic flowchart of another processing method consistent with the present disclosure.

FIG. 4 schematically shows an image data stream consistent with the present disclosure.

FIG. 5 schematically shows another image data stream consistent with the present disclosure.

FIG. 6 schematically shows another image data stream consistent with the present disclosure.

FIG. 7 schematically shows another image data stream consistent with the present disclosure.

FIG. 8 schematically shows the architecture of a processing apparatus consistent with the present disclosure.

### DETAILED DESCRIPTION OF THE EMBODIMENTS

The technical solutions in the embodiments of the present disclosure will be described below with reference to the accompanying drawings. Obviously, the described embodiments are only some embodiments of the present disclosure, not all embodiments. Based on the embodiments of the present disclosure, all other embodiments obtained by those skilled in the art without creative effort are within the scope of the present disclosure.

The terms associated with “first,” “second,” etc., in the specification, claims, and the drawings of the present disclosure are used to distinguish similar objects and do not represent a specific order or sequence. It should be understood that the terms used in this way can be interchanged where appropriate, so that the embodiments of the present disclosure can be implemented in an order other than those illustrated or described herein. Furthermore, the terms “including” and “comprising,” and any variations thereof, are intended to cover non-exclusive inclusion. For example, a process, method, system, product, or apparatus that includes a series of elements not only includes those elements but also includes other elements not explicitly listed, or elements inherent to such a process, method, article, or apparatus. Without further limitations, an element defined by the phrase “comprising a . . . ” does not exclude the presence of other identical elements in the process, method, article, or device that includes the said element.

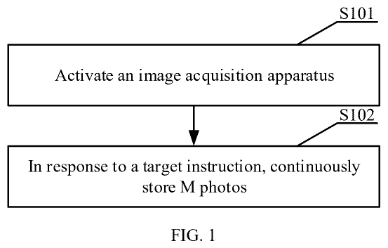

As shown in FIG. 1, a flowchart of a processing method consistent with the present disclosure is applied to a smart device and includes the following.

At S101, an image acquisition apparatus is activated.

The image acquisition apparatus is configured to sense ambient light and generate captured images.

In some embodiments, the image acquisition apparatus can be a module integrated into the smart device, or a module remotely controlled by the smart device. For example, the image acquisition apparatus can be a camera on a drone remotely controlled by a mobile phone.

At S102, In response to a target instruction, M photos are continuously stored.

The M photos are images fused from multiple captured images acquired by the image acquisition apparatus, where M is a positive integer greater than or equal to 2.

The process of continuously storing M photos in response to a target instruction can achieve continuous shooting without waiting in a mode where the smart device needs to wait for the image acquisition apparatus to process the captured images. Whether the smart device performs the process shown in S102 can be manually set by the user, for example, the smart device can perform the process shown in S102 by setting a night scene shooting mode. For example, the smart device can also determine insufficient light and automatically enter the night scene shooting mode based on the preview image provided by the smart device.

In some embodiments, the present disclosure can be applied to shooting scenarios such as night scene shooting, multi-frame noise reduction shooting, long-distance shooting, and High Dynamic Range Imaging (HDRI) scenarios. Correspondingly, each shooting scenario corresponds to a dedicated shooting mode, and the user can achieve continuous shooting without waiting in any shooting scenario by setting the shooting mode.

In some embodiments, the target instruction can be triggered by a shooting control based on a target input operation.

In some embodiments, the target input operation includes pressing and holding the shooting control, or sliding the shooting control, or pressing the shooting control multiple times in a short period, or other shooting control trigger actions that can be determined as continuous shooting.

In some embodiments, the shooting control can be software or hardware. Software refers to a virtual button on a smart device used to control shooting, and hardware refers to a physical button on a smart device that controls shooting (e.g., a shutter button).

In some embodiments, during the time the shooting control is held down, the target instruction can be broken down into multiple image acquisition instructions. Images are acquired. Photos are processed and stored continuously. The next image acquisition instruction is executed only after the previous photo has been processed.

For example, the shooting control was held down for a total of 5 seconds. Therefore, the target instruction can be broken down into 5 image acquisition instructions. A set of captured images is acquired using the image acquisition apparatus every 1 second, and the set of captured images is fused to obtain a corresponding photo.

In some embodiments, during the time the shooting control is held down, the target instruction can be broken down into multiple image acquisition instructions. Images are acquired continuously, with some captured images being shared. Once enough images have been acquired, the next image acquisition instruction can be executed before the photo corresponding to the current image acquisition instruction is processed.

For example, the shooting control was held down for a total of 5 seconds. The target instruction can be broken down into 5 image acquisition instructions, a set of captured images is acquired using the image acquisition apparatus every 1 second. If an image is acquired in any 1-second interval that can be shared with the next 1-second interval, the next image acquisition instruction can be executed before the photo corresponding to the current 1-second image acquisition instruction is processed.

In some embodiments, for continuous shooting of multiple captured images processed by an algorithm, the target input operation of the shooting control can be obtained, and the target instruction is determined based on the target input operation. The target instruction includes the N-th shooting instruction and the (N+1)-th shooting instruction, where N is greater than or equal to 1.

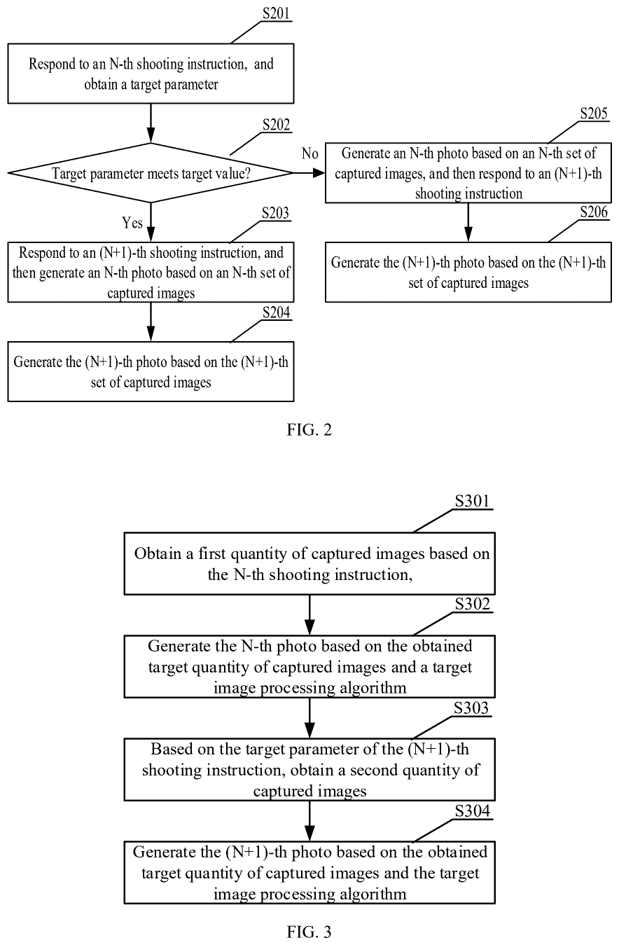

For the implementation process of determining the target instruction based on the target input operation and then using that target instruction to obtain M photos, reference can be made to the processes and description shown in FIGS. 2 and 3.

The process shown in S101-S102 above can reduce shooting delay time, enabling continuous shooting without long waits even when multiple captured images need to be processed to generate a single photo. This optimizes the user's shooting experience. Furthermore, in continuous shooting scenarios, since the waiting time for restarting the shooting control is reduced, the processing time for multiple photos obtained during continuous shooting is also shortened, thus reducing the shooting delay time and resulting in a better user shooting experience.

FIG. 2 is a flowchart of another processing method consistent with the present disclosure, including the following.

At S201, an N-th shooting instruction is responded to, and a target parameter is obtained.

The N-th set of captured images are images acquired by the image acquisition apparatus, where N is greater than or equal to 1.

The target parameter includes one of the shooting parameters corresponding to the (N+1)-th shooting instruction, and parameters used to represent the shooting environment before the (N+1)-th shooting instruction is determined.

In some embodiments, the shooting parameters include, but are not limited to, exposure values (EV), depth of field, focal length, white balance, and other parameters.

In some embodiments, in low-light night scene shooting scenarios, the captured images obtained by the image acquisition apparatus at the baseline exposure value may have problems of overexposure in bright areas or underexposure in dark areas. Therefore, in night scene shooting scenarios, the image acquisition apparatus will acquire captured images at different exposure values, and generate multiple captured images obtained at different exposure values into a single photo, so as to darken potentially overexposed areas and brighten underexposed areas in the photo.

In some embodiments, the captured images obtained based on the exposure value can be considered as exposure data. Depending on the exposure value, the exposure data can be first exposure data (denoted as EV0), second exposure data (denoted as EV+), and third exposure data (denoted as EV−). The first exposure data represents the captured image obtained by the image acquisition apparatus using a specified baseline exposure value, the second exposure data represents the captured image obtained by the image acquisition apparatus using a first exposure value (i.e., an exposure value higher than the specified baseline exposure value), and the third exposure data represents the captured image obtained by the image acquisition apparatus using a second exposure value (i.e., an exposure value lower than the specified baseline exposure value).

In some embodiments, in long-distance shooting scenarios with excessively long focal lengths, the images acquired by the image acquisition apparatus at the baseline focal length may suffer from blurry foreground or mid-ground shots. Therefore, in long-distance shooting scenarios, the image acquisition apparatus acquires images at different focal lengths, and then combines the multiple images acquired at different focal lengths into a single photo, thereby ensuring that the photo is focused at an appropriate distance.

In some embodiments, the captured images based on focal length can be considered as focal length data. Based on the different focal lengths, the focal length data can be first focal length data, second focal length data, and third focal length data. The first focal length data represents the image acquired by the image acquisition apparatus using a specified baseline focal length. The second focal length data represents the image acquired by the image acquisition apparatus using a first focal length (i.e., a focal length greater than the specified baseline focal length). The third focal length data represents the image acquired by the image acquisition apparatus using a second focal length (i.e., a focal length less than the specified baseline focal length).

Both exposure data and focal length data are data types of captured images. For any data type of captured image, the data type and data quantity involved in the set of captured images needed for generating a photo can be determined based on multiple factors such as the illuminance and photosensitivity of the image acquisition apparatus.

For example, the set of captured images needed for generating a photo can be obtained by training a machine learning model based on sample data (which includes illuminance, photosensitivity, captured images, and images). Consistent with the present disclosure, the method of determining the data type and data quantity of the captured image set is not limited. In an embodiment where captured images are obtained based on exposure value, when the shooting control (e.g., shutter) is first triggered, the image acquisition apparatus determines the set of captured images needed to generate an optimal photo based on the illuminance and/or photosensitivity.

For example, based on factors such as the illuminance and photosensitivity of the image acquisition apparatus, it is determined that 4 pieces of first exposure data (EV0s) are needed to form a first captured image, and 1 piece of second exposure data (EV+) and 1 piece of third exposure data (EV−) are needed to form a second captured image, in order to generate an optimal photo in a night scene shooting scenario. Similarly, in long-distance shooting, it can be determined that 2 pieces of first focal length data are needed to form the first captured image, and 1 piece of second focal length data and 1 piece of third focal length data are needed to form the second captured image, in order to generate an optimal photo in a long-distance shooting scenario. As another example, it can be determined that 2 pieces of first exposure data (EV0) are needed to form the first captured image, and 1 piece of second exposure data (EV+) and 1 piece of third exposure data (EV−) are needed to form the second captured image, in order to generate an optimal photo in an HDRI scenario.

In some embodiments, for night scene shooting scenarios, the shooting parameters corresponding to the second exposure data and third exposure data can be considered as exposure compensation, which can darken overly bright areas or brighten overly dark areas, while the shooting parameters corresponding to the first exposure data can be considered as basic exposure. Correspondingly, the image acquisition apparatus obtains the corresponding captured images based on exposure compensation and basic exposure.

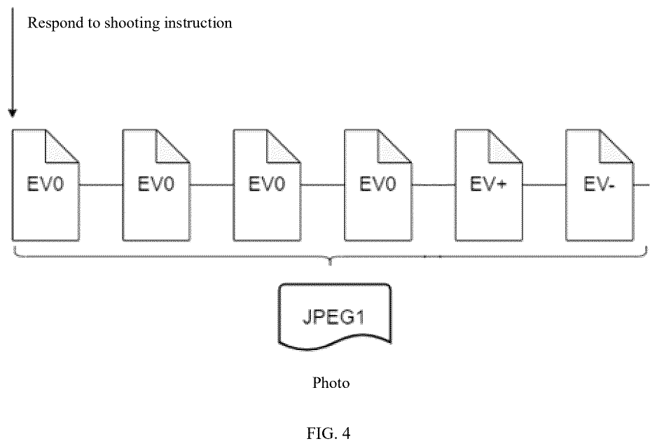

As shown in FIG. 4, for example, the set of captured images needed for generating an optimal photo includes 6 pieces of exposure data continuously acquired by the image acquisition apparatus. The acquisition order of the 6 pieces of exposure data is first exposure data (EV0), first exposure data (EV0), first exposure data (EV0), first exposure data (EV0), second exposure data (EV+), and third exposure data (EV−).

The parameters used to represent the shooting environment can be referred to as environmental parameters. These environmental parameters include, but are not limited to brightness, humidity, weather, temperature, etc.

In some embodiments, the environmental parameters can be determined through a sensing unit of the image acquisition apparatus.

For example, for brightness, the sensing unit can be a photosensitive unit used to collect brightness data within the shooting range of the image acquisition apparatus. For humidity, the sensing unit can be a humidity sensor used to collect humidity data around the image acquisition apparatus.

In some embodiments, the environmental parameters collected by the sensing unit can also be displayed, for example, by displaying the current image acquired by the image acquisition apparatus's lens through a preview interface, and displaying the current environmental parameters on the preview interface.

At S202, it is determined that whether the target parameter meets a target value.

If the target parameter meets the target value, then S203 is executed. If the target parameter does not meet the target value, S205 is executed.

The target parameter meeting the target value can mean that a difference between the target parameters corresponding to the N-th shooting instruction and the (N+1)-th shooting instruction is small. The target parameter meeting the target value can also mean that the shooting scene corresponding to the N-th shooting instruction and the (N+1)-th shooting instruction does not change significantly.

In some embodiments, when a shooting target is an animal, the image acquisition apparatus may shoot in scenes with changing light conditions. For example, the shooting direction shifted from being sideways to the light source to being directly facing the light source. The difference between the target parameters corresponding to the N-th shooting instruction and the (N+1)-th shooting instruction can be understood as a change in ambient light. If the difference between the target parameters corresponding to the N-th shooting instruction and the (N+1)-th shooting instruction falls within a specified threshold range, meaning the change in ambient light is small, and the target parameter of the (N+1)-th shooting instruction meet the target value.

At S203, an (N+1)-th shooting instruction is responded to, and then an N-th photo is generated based on an N-th set of captured images.

After S203 is executed, S204 is executed.

Since the target parameter meets the target value, it can be determined that the N-th set of captured images and the subsequent (N+1)-th set of captured images collected by the image acquisition apparatus can share some captured images. Therefore, it is possible to respond to the (N+1)-th shooting instruction in advance without waiting for the image acquisition apparatus to generate the N-th photo.

In some embodiments, the (N+1)-th shooting instruction, taking the second shooting instruction as an example, can be triggered by the user using a shooting control (e.g., pressing a physical shooting button).

For example, the shooting instruction can be broken down into n sub-instructions. The i-th sub-instruction acquires some of the images needed to generate one photo, and the remaining captured images and image processing needed to generate one photo are performed after the (i+1)-th target sub-instruction. Of course, the remaining captured images need to meet specified conditions. If the remaining captured images do not meet the specified conditions, the image processing is also performed after the (i+1)-th target sub-instruction, and the image acquisition is handled by the backend, eliminating the need to wait for processing time.

In some embodiments, the specified condition refers to the remaining captured images, which need to be able to be combined with the previously captured images to generate an optimal photo. Taking an example of exposure data as captured images, if the previously captured image is the first exposure data (EV0), then the remaining captured images are exposure compensation (i.e., EV+ and EV−). The exposure compensation needs to solve the exposure problem of the first exposure data to determine whether the exposure compensation meets the specified condition.

In related technologies, the user needs to keep the image acquisition apparatus stable to shoot multiple images to generate a single photo, and the shutter cannot be triggered again before the photo is generated, or the shutter can be pressed but no images can be acquired. The present disclosure allows the shutter to be triggered and the image of the next shooting scene to be acquired before the photo is generated. The target parameter of the next shooting scene needs to meet the target value. For example, in the process of continuously shooting two photos, the image acquisition apparatus usually needs to collect a set of EV0, EV0, EV0, EV0, EV+, EV− before the shutter is allowed to be triggered again to collect another set of EV0, EV0, EV0, EV0, EV+, EV−. However, the embodiments of the present disclosure allow the shutter to be triggered after EV0, EV0, EV0, EV0 in the first set are acquired, and before EV+ in the first set is acquired. After the shutter is triggered, EV+, EV−, and the second set of EV0, EV0, EV0, EV0 can be acquired subsequently. Obviously, the user does not need to wait for a long time before being allowed to trigger the shutter when shooting a photo, improving the user's shooting experience.

Before the N-th photo is generated, responding to the (N+1)-th shooting instruction to obtain the (N+1)-th set of captured images, compared to each shooting instruction can only be responded to after the photo is determined to be generated, this reduces the waiting time for the user to start the shooting control, and the user's shooting experience is significantly improved. In addition, in the scenario of continuous shooting of multiple photos, allowing the shooting instruction to be respond to in advance can reduce the perceived shooting delay and shorten the overall shooting time.

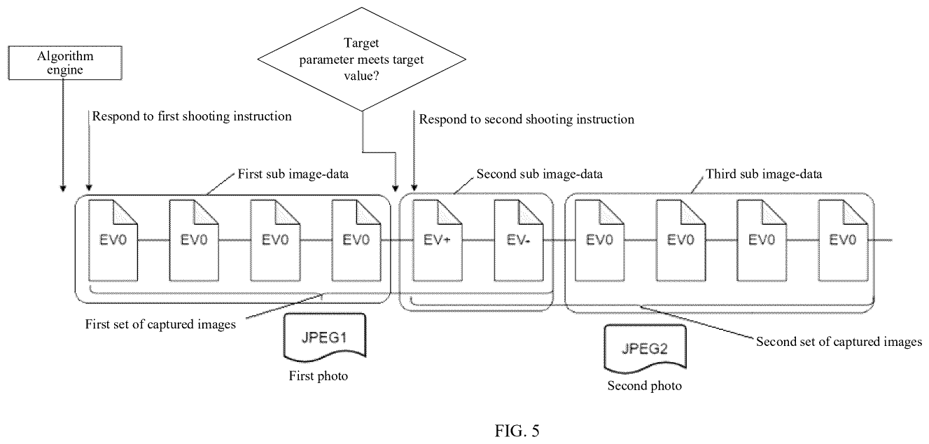

In some embodiments, each time the image acquisition apparatus triggers the shutter, a set of captured images can be obtained. Each shutter trigger represents a response to a shooting instruction. When the shutter is first triggered, the image acquisition apparatus determines which images need to be collected. As shown in FIG. 5, when the shutter is first triggered, responding to the first shooting instruction, the image acquisition apparatus uses an algorithm engine to determine that 4 EV0, 1 EV+, and 1 EV− are needed to generate an optimal photo, based on the illumination and photosensitivity. Furthermore, before the second captured image (i.e., EV+ and EV−) is acquired, it is needed to determine whether the target parameter corresponding to the second shooting instruction meets the target value. If the target parameter meets the target value, the shutter is allowed to be triggered again to respond to the second shooting instruction. After the second captured image is obtained, the first photo is generated based on the first captured image and second captured image.

As shown in FIG. 5, for example, the image acquisition apparatus needs a set of EV0, EV0, EV0, EV0, EV+, and EV− to generate an optimal photo. Therefore, two photos typically need two sets of EV0, EV0, EV0, EV0, EV+, and EV−. In existing technology, the image acquisition apparatus can only respond to another shooting instruction to obtain another set of EV0, EV0, EV0, EV0, EV+, and EV− after a first set of EV0, EV0, EV0, EV0, EV+, and EV− is collected. However, consistent with the present disclosure, first sub image-data and second sub image-data can be considered as the images acquired by the image acquisition apparatus in response to a first shooting instruction, and second sub image-data and third sub image-data can be considered as the images acquired by the image acquisition apparatus in response to a second shooting instruction. The first sub image-data includes EV0, EV0, EV0, EV0, the second sub image-data can be considered as being obtained after the first sub image-data, and the second sub image-data includes EV+ and EV−, and the third sub image-data includes EV0, EV0, EV0, EV0. The second shooting instruction is responded to after the last EV0 in the first sub image-data is obtained, but before EV+ in the second sub image-data is obtained. That is, before the first photo is generated, the second shooting instruction is responded to in order to obtain the captured images needed to generate the second photo. The generating process of the second photo can share the second sub image-data with the N-th photo, thereby storing shooting time and improving user experience.

At S204, the (N+1)-th photo is generated based on the (N+1)-th set of captured images.

The N-th set of captured images and the (N+1)-th set of captured images include at least one captured image that can be shared with each other.

In some embodiments, since the N-th set of captured images and the (N+1)-th set of captured images include at least one captured image that can be shared with each other, the collection time of the (N+1)-th set of captured images will be advanced, thereby improving the generating efficiency of the (N+1)-th photo.

As shown in FIG. 5, for example, the first photo and the second photo share the EV+ and EV-shown in the second sub image-data. As another example, the N-th photo and the (N+1)-th photo can also share other sub image-data (e.g., EV0, EV0, EV0, EV0).

In a continuous shooting scenario, the generating of two consecutive photos can share some captured images, which can effectively reduce the collection time of the captured image sets compared to the related technology, thereby improving the photo generation speed and advancing the response time of the shooting instruction, thus improving the user's shooting experience.

At S205, an N-th photo is generated based on an N-th set of captured images, and then an (N+1)-th shooting instruction is responded to.

After S205 is executed, S206 is executed.

At S206, the (N+1)-th photo is generated based on the (N+1)-th set of captured images.

The N-th set of captured images and the (N+1)-th set of captured images have no intersection, that is, the N-th set of captured images and the (N+1)-th set of captured images do not share captured images.

In order to respond to the (N+1)-th shooting instruction before the N-th photo is generated, the target parameter corresponding to the (N+1)-th shooting instruction need to meet the target value.

In the process shown in S201-S206 above, since the (N+1)-th shooting instruction is responded to before the N-th photo is generated, the waiting time for the (N+1)-th shooting instruction is reduced, therefore, the generation time of the (N+1)-th photo will be advanced, shortening the shooting delay time of continuous shooting, and resulting in a better user shooting experience.

FIG. 3 is another processing method consistent with the present disclosure, including the following processes.

At S301, a first quantity of captured images are obtained based on the N-th shooting instruction.

The first quantity of captured images refers to the images acquired by the image acquisition apparatus.

In some embodiments, if the N-th shooting instruction represents the first shooting instruction, the first quantity acquired by the image acquisition apparatus is a target quantity.

In some embodiments, taking shooting parameters as target parameter, these shooting parameters can be exposure values, and exposure values can be further divided into base exposure and exposure compensation. The image acquisition apparatus uses the base exposure to obtain 4 EV0s, and uses exposure compensation to obtain 1 EV+ and 1 EV−. Therefore, when the target parameter corresponding to the N-th shooting instruction is the base exposure, the first quantity is 4. When the target parameter corresponding to the N-th shooting instruction is exposure compensation, the first quantity is 2.

At S302, the N-th photo is generated based on the obtained target quantity of captured images and a target image processing algorithm.

The target quantity is determined by the target parameter of the N-th shooting instruction.

For example, before the set of captured images is obtained in response to the first shooting instruction, the image acquisition apparatus also uses a built-in algorithm engine to analyze the data type and data quantity of captured images needed to generate an optimal photo based on illuminance and photosensitivity. For example, the image acquisition apparatus uses a built-in algorithm engine to analyze how many EV0s, how many EV+s, and the level of EV+ are needed to generate the first photo. The data quantity is the first data quantity. For example, in response to the first shooting instruction, the set of captured images needed to generate an optimal photo includes EV0, EV0, EV0, EV0, EV+, EV−. Therefore, the target quantity can be 6.

At S303, a second quantity of captured images are obtained based on the target parameter of the (N+1)-th shooting instruction.

The second quantity of captured images refers to the images acquired by the image acquisition apparatus. The first quantity is different from the second quantity, the target quantity is greater than or equal to the first quantity, and the target quantity is greater than the second quantity.

In some embodiments, the shooting parameters are used as target parameter. These shooting parameters can be the exposure value, the exposure value can be further divided into base exposure and exposure compensation. The image acquisition apparatus obtains 4 EV0s using the base exposure, and 1 EV+ and 1 EV-using exposure compensation. Therefore, when the target parameter corresponding to the (N+1)-th shooting instruction is the base exposure, the second quantity is 4. When the target parameter corresponding to the (N+1)-th shooting instruction is the exposure compensation, the second quantity is 2.

At S304, the (N+1)-th photo is generated based on the obtained target quantity of captured images and the target image processing algorithm.

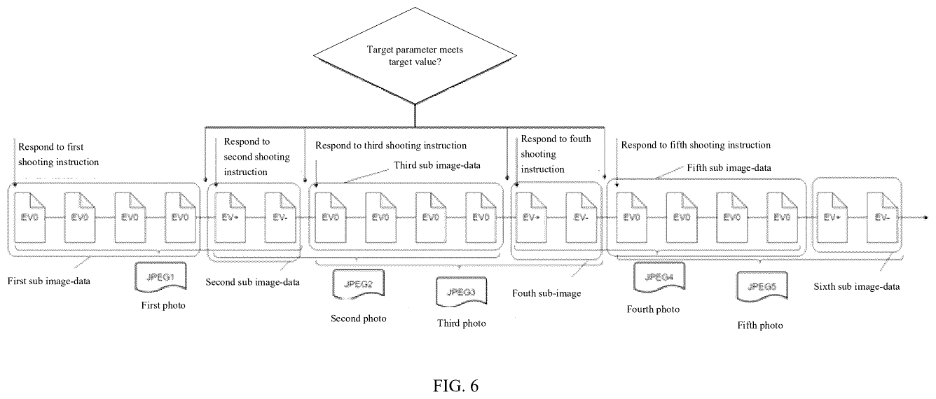

As shown in FIG. 6, for example, in response to the first shooting instruction, the first sub image-data is obtained (the corresponding quantity of captured images is 4). Before the first photo is generated, in response to the second shooting instruction, the second sub image-data is obtained (the corresponding quantity of captured images is 2). Before the second photo is generated, in response to the third shooting instruction, the third sub image-data is obtained (the corresponding quantity of captured images is 4). Before the third photo is generated, in response to the fourth shooting instruction, the fourth sub image-data is obtained (the corresponding quantity of captured images is 2). Before the fourth photo is generated, in response to the fifth shooting instruction, the fifth sub image-data and sixth sub image-data are obtained (the corresponding quantity of captured images is 6), and then the fifth photo is generated.

As shown in FIG. 6, for example, based on the first sub image-data and the second sub image-data, as the first set of captured images, the first photo is generated. Based on the second sub image-data and the third sub image-data, as the second set of captured images, the second photo is generated. Based on the third sub image-data and the fourth sub image-data, as the third set of captured images, the third photo is generated. Based on the fourth sub image-data and the fifth sub image-data, as the fourth set of captured images, the fourth photo is generated. Based on the fifth sub image-data and the sixth sub image-data, as the fifth set of captured images, the fifth photo is generated.

As shown in FIG. 6, for example, the first photo and second photo share the second sub image-data, the second photo and third photo share the third sub image-data, the third photo and fourth photo share the fourth sub image-data, the fourth photo and fifth photo share the fifth sub image-data, and so on, with the N-th and (N+1)-th photos sharing the (N+1)-th sub image-data.

In addition, in response to the first shooting instruction, the image acquisition apparatus analyzes the data type and data quantity of captured images needed to generate an optimal photo. Furthermore, before the second sub image-data, third sub image-data, fourth sub image-data, and fifth sub image-data are acquired, the image acquisition apparatus determines, based on the target parameter corresponding to each shooting instruction, whether the next shooting instruction is allowed to be responded to before the photo corresponding to the current shooting instruction is generated.

For example, in the continuous shooting scenario shown in FIG. 6, the target parameter corresponding to the second shooting instruction, the target parameter corresponding to the third shooting instruction, the target parameter corresponding to the fourth shooting instruction, and the target parameter corresponding to the fifth shooting instruction all meet their corresponding target value.

Before the image data is acquired each time, the target parameter corresponding to each shooting instruction can be obtained by using the sensing unit of the image acquisition apparatus. Based on the target parameter, whether to respond to the shooting instruction in advance can be determined, allowing two temporally adjacent photos to share some of the captured image, thus shortening the waiting time needed to generate each photo.

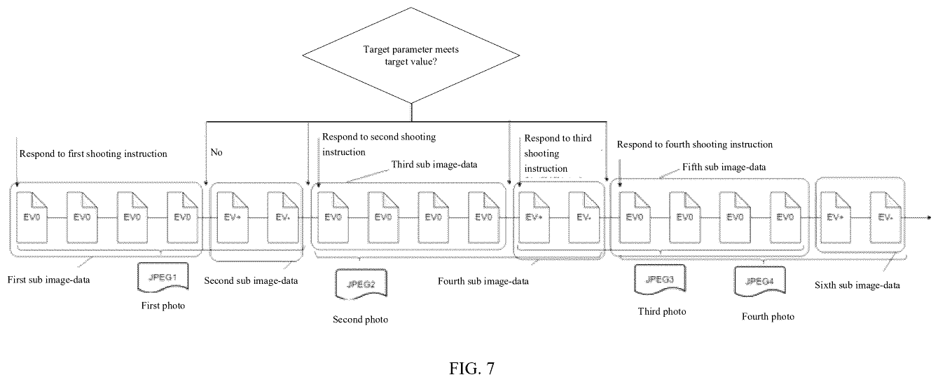

As shown in FIG. 7, for example, if some of the captured images in the first set of captured images (i.e., the second sub image-data) do not meet sharing conditions (i.e., the target parameter corresponding to the second shooting instruction do not meet the target value, and the first photo and second photo cannot share the second sub image-data), then the second shooting instruction will not be responded to before the third sub image-data is acquired. Only after the acquisition of the second sub image-data is completed will the second shooting instruction be responded to. If the subsequent third sub image-data, fourth sub image-data, and fifth sub image-data all meet the sharing conditions, then responding to the shooting instruction in advance is allowed before the corresponding photos are generated. Compared to the quantity of photos obtained in FIG. 6, since the second sub image-data cannot be shared for the generating of the first photo and second photo, one fewer photo will be obtained from the same captured image.

In continuous shooting scenarios, the embodiments of the present disclosure can generate photos using fewer captured images, thus the generation speed of multiple photos is improved.

In some embodiments, the generation speed of M photos is improved due to the fact that during the continuous shooting process to obtain M photos, the captured images from previous shots are combined with the captured images from the current shot to determine the photo taken at the current moment, thereby increasing the generation speed of the photo taken at the current moment.

Conventional technology needs 2n pieces of sub image-data to obtain n photos. If, except for the first sub image-data (EV0, EV0, EV0, EV0 obtained in response to the first shooting instruction), each of the remaining pieces of sub image-data meets the sharing conditions, then the embodiments of the present disclosure can generate n photos with only n+1 sub image-data. The quantity of captured images needed is less than in conventional technology.

In some embodiments, if, except for the first sub image-data (EV0, EV0, EV0, EV0), there is one piece of sub image-data in each of the remaining pieces of sub image-data that does not meet the sharing conditions, then n=m+1+1. If there are two sub image-data in the remaining sub image-data that do not meet the sharing conditions, then n=m+1+2. Therefore, if, except for the first sub image-data, there are s pieces of sub image-data that do not meet the sharing conditions, then n=m+1+s, where s is a positive integer.

Furthermore, the method consistent with the embodiments of the present disclosure can be applied to continuous shooting scenarios and allows for slight misalignment of the shooting target in continuous shooting scenarios. Further, the captured images involved in the embodiments of the present disclosure, in addition to exposure data such as EV0, EV+, and EV−, can also be other types of captured images such as focal length data. Of course, the application of other types of captured images in continuous shooting scenarios is similar in the embodiments of the present disclosure.

In related technologies, such as night scene mode and HDRI mode continuous shooting scenarios, photos can only be taken one by one, and each photo needs a long waiting time. In the present disclosure, the (N+1)-th shooting instruction can be respond to before the N-th photo is generated, thereby obtaining the (N+1)-th set of captured images in advance, reducing the waiting time for taking each photo and allowing the user to shoot continuously through target input operations, improving the user's shooting experience.

The process shown in S301-S304 enables the sharing some of captured images in the generating process of two adjacent photos in a continuous shooting scenario, that is, rationally utilizing some of captured images in the N-th set of captured images to generate the (N+1)-th photo, thereby speeding up the generating of multiple photos. Correspondingly, the response speed to multiple shooting instructions can be improved, thus reducing shooting delay and improving the user's shooting experience.

Corresponding to the processing method consistent with the present disclosure, the present disclosure further provides a processing apparatus.

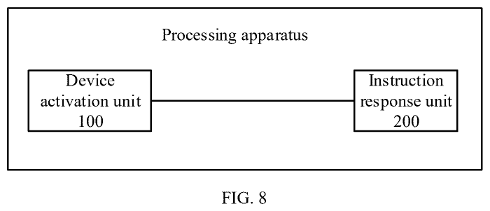

FIG. 8 schematically shows the architecture of a processing apparatus consistent with the present disclosure, the processing apparatus includes the following units.

Device activation unit 100, configured to activate the image acquisition apparatus, and the image acquisition apparatus is configured to sense ambient light and generate captured images.

Instruction response unit 200, configured to respond to a target instruction and continuously store M photos. M photos are images fused from multiple captured images acquired by the image acquisition apparatus, and M is a positive integer greater than or equal to 2.

In some embodiments, the instruction response unit 200 is configured to respond to the N-th shooting instruction, generate the N-th photo based on the N-th set of captured images, where the N-th set of captured images are images acquired by the image acquisition apparatus. The instruction response unit 200 is further configured to respond to the (N+1)-th shooting instruction, generate the (N+1)-th photo based on the (N+1)-th set of captured images, where the (N+1)-th set of captured images are images acquired by the image acquisition apparatus. Before the N-th photo is obtained based on the N-th set of captured images, the instruction response unit 200 is configured to respond to the (N+1)-th shooting instruction, where N is greater than or equal to 1.

In some embodiments, the instruction response unit 200 is further configured to obtain target parameter. If the target parameter meets the target value, the instruction response unit 200 respond to the (N+1)-th shooting instruction. The target parameter includes one of a shooting parameter corresponding to the (N+1)-th shooting instruction, and a parameter used to represent the shooting environment before the (N+1)-th shooting instruction is determined.

In some embodiments, the N-th set of captured images and the (N+1)-th set of captured images include at least one captured image that can be shared with each other.

In some embodiments, the instruction response unit 200 is configured to obtain a first quantity of captured images based on the N-th shooting instruction, where the first quantity of captured images are images acquired by the image acquisition apparatus, generate the N-th photo based on the obtained target quantity of captured images and the target image processing algorithm. The target quantity is determined by the target parameter of the N-th shooting instruction. In response to the (N+1)-th shooting instruction, generating the (N+1)-th photo based on the (N+1)-th set of captured images includes obtaining a second quantity of captured images based on the target parameter of the (N+1)-th shooting instruction, where the second quantity of captured images are images acquired by the image acquisition apparatus, the first quantity is different from the second quantity, the target quantity is greater than or equal to the first quantity, the target quantity is greater than the second quantity, generating the (N+1)-th photo based on the obtained target quantity of captured images and the target image processing algorithm.

In some embodiments, the instruction response unit 200 is configured to, if the N-th shooting instruction represents the first shooting instruction, the first quantity of images acquired by the image acquisition apparatus is the target quantity.

The various units shown above can reduce shooting delay time, achieve continuous shooting without waiting, thereby improving the user's shooting experience. Furthermore, in continuous shooting scenarios, since the waiting time for restarting the shooting control is reduced, the processing time of multiple photos obtained from continuous shooting is also shortened, thus shortening the shooting delay time of continuous shooting and providing a better user shooting experience.

The present disclosure also provides an electronic device, including a processor, a memory, and a bus. The processor is connected to the memory through the bus, the memory is configured to store programs, and the processor is configured to execute the programs. The programs are executed to perform the processing method provided in the present disclosure.

If the functions described in the embodiments of the present disclosure are implemented in the form of software functional units and sold or used as independent products, they can be stored in a computer-readable storage medium. Based on this, some embodiments of the present disclosure that contributes to part of the technical solution can be embodied in the form of a software product, which is stored in a storage medium and includes several instructions to enable a computing device (which can be a personal computer, server, mobile computing device, or network device, etc.) to perform all or part of the methods described in the embodiments of the present disclosure. The aforementioned storage medium includes various media that can store program code, such as USB flash drives, mobile hard drives, read-only memory, random access memory, magnetic disks, or optical discs.

The various embodiments in this specification are described in a progressive manner. Each embodiment focuses on the differences from other embodiments, and the similar or identical parts between the embodiments can be cross-referenced.

The above description of the disclosed embodiments enables those skilled in the art to implement or use present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but is intended to be accorded the broadest scope consistent with the principles and novel features disclosed herein.

What is claimed is:

1. A processing method comprising:
activating an image acquisition apparatus configured to sense ambient light to generate captured images; and
continuously storing M photos in response to a target instruction, the M photos being generated by fusing the captured images, and M being a positive integer greater than or equal to 2.

2. The method according to claim 1, wherein continuously storing the M photos in response to the target instruction includes:
responding to an N-th shooting instruction and generating an N-th photo based on an N-th set of captured images acquired by the image acquisition apparatus; and
responding to an (N+1)-th shooting instruction and generating an (N+1)-th photo based on an (N+1)-th set of captured images acquired by the image acquisition apparatus, the (N+1)-th shooting instruction being responded to before the N-th photo is obtained based on the N-th set of captured images, and N being an integer greater than or equal to 1.

3. The method according to claim 2, further comprising, after the N-th shooting instruction is responded to and before the N-th photo is generated based on the N-th set of captured images:
obtaining a target parameter including one of a shooting parameter corresponding to the (N+1)-th shooting instruction and a parameter used to represent a shooting environment before the (N+1)-th shooting instruction is determined;
wherein responding to the (N+1)-th shooting instruction includes responding to the (N+1)-th shooting instruction in response to the target parameter satisfying a target value.

4. The method according to claim 3, wherein the N-th set of captured images and the (N+1)-th set of captured images include at least one shared captured image.

5. The method according to claim 2, wherein:
responding to the N-th shooting instruction and generating the N-th photo based on the N-th set of captured images includes:
obtaining a first quantity of captured images based on the N-th shooting instruction, the first quantity of captured images being acquired by the image acquisition apparatus; and
generating the N-th photo based on a target quantity of captured images being obtained and a target image processing algorithm, the target quantity being determined by a target parameter of the N-th shooting instruction and being greater than or equal to the first quantity; and
responding to the (N+1)-th shooting instruction and generating the (N+1)-th photo based on the (N+1)-th set of captured images includes:
obtaining a second quantity of captured images based on the target parameter of the (N+1)-th shooting instruction, the second quantity of captured images being acquired by the image acquisition apparatus, and the target quantity being greater than the second quantity; and
generating the (N+1)-th photo based on a target quantity of captured images being captured and the target image processing algorithm.

6. The method according to claim 5, wherein obtaining the first quantity of captured images based on the N-th shooting instruction includes:
in response to the N-th shooting instruction representing a first shooting instruction, determining the first quantity as the target quantity.

7. An electronic device comprising:
a bus;
a processor; and
a memory connected to the processor through the bus, and storing an application program that, when executed by the processor, causes the electronic device to:
activate an image acquisition apparatus configured to sense ambient light to generate captured images; and
continuously store M photos in response to a target instruction, the M photos being generated by fusing the captured images, and M being a positive integer greater than or equal to 2.

8. The electronic device according to claim 7, wherein the application program, when executed by the processor, further causes the electronic device to, when continuously storing the M photos in response to the target instruction:
respond to an N-th shooting instruction and generate an N-th photo based on an N-th set of captured images acquired by the image acquisition apparatus; and
respond to an (N+1)-th shooting instruction and generate an (N+1)-th photo based on an (N+1)-th set of captured images acquired by the image acquisition apparatus, the (N+1)-th shooting instruction being responded to before the N-th photo is obtained based on the N-th set of captured images, and N being an integer greater than or equal to 1.

9. The electronic device according to claim 8, wherein the application program, when executed by the processor, further causes the electronic device to:
after the N-th shooting instruction is responded to and before the N-th photo is generated based on the N-th set of captured images:
obtain a target parameter including one of a shooting parameter corresponding to the (N+1)-th shooting instruction and a parameter used to represent a shooting environment before the (N+1)-th shooting instruction is determined; and
when responding to the (N+1)-th shooting instruction, respond to the (N+1)-th shooting instruction in response to the target parameter satisfying a target value.

10. The electronic device according to claim 9, wherein the N-th set of captured images and the (N+1)-th set of captured images include at least one shared captured image.

11. The electronic device according to claim 8, wherein the application program, when executed by the processor, further causes the electronic device to:
when responding to the N-th shooting instruction and generating the N-th photo based on the N-th set of captured images:
obtain a first quantity of captured images based on the N-th shooting instruction, the first quantity of captured images being acquired by the image acquisition apparatus; and
generate the N-th photo based on a target quantity of captured images being obtained and a target image processing algorithm, the target quantity being determined by a target parameter of the N-th shooting instruction and being greater than or equal to the first quantity; and
when responding to the (N+1)-th shooting instruction and generating the (N+1)-th photo based on the (N+1)-th set of captured images:
obtain a second quantity of captured images based on the target parameter of the (N+1)-th shooting instruction, the second quantity of captured images being acquired by the image acquisition apparatus, and the target quantity being greater than the second quantity; and
generate the (N+1)-th photo based on a target quantity of captured images being captured and the target image processing algorithm.

12. The electronic device according to claim 11, wherein the application program, when executed by the processor, further causes the electronic device to, when obtaining the first quantity of captured images based on the N-th shooting instruction:
in response to the N-th shooting instruction representing a first shooting instruction, determine the first quantity as the target quantity.

13. A non-transitory computer-readable storage medium storing an application program that, when executed by a processor, causes an electronic device including the processor to:
activate an image acquisition apparatus configured to sense ambient light to generate captured images; and
continuously store M photos in response to a target instruction, the M photos being generated by fusing the captured images, and M being a positive integer greater than or equal to 2.

14. The storage medium according to claim 13, wherein the application program, when executed by the processor, further causes the electronic device to, when continuously storing the M photos in response to the target instruction:
respond to an N-th shooting instruction and generate an N-th photo based on an N-th set of captured images acquired by the image acquisition apparatus; and
respond to an (N+1)-th shooting instruction and generate an (N+1)-th photo based on an (N+1)-th set of captured images acquired by the image acquisition apparatus, the (N+1)-th shooting instruction being responded to before the N-th photo is obtained based on the N-th set of captured images, and N being an integer greater than or equal to 1.

15. The storage medium according to claim 14, wherein the application program, when executed by the processor, further causes the electronic device to:
after the N-th shooting instruction is responded to and before the N-th photo is generated based on the N-th set of captured images:
obtain a target parameter including one of a shooting parameter corresponding to the (N+1)-th shooting instruction and a parameter used to represent a shooting environment before the (N+1)-th shooting instruction is determined; and
when responding to the (N+1)-th shooting instruction, respond to the (N+1)-th shooting instruction in response to the target parameter satisfying a target value.

16. The storage medium according to claim 15, wherein the N-th set of captured images and the (N+1)-th set of captured images include at least one shared captured image.

17. The storage medium according to claim 14, wherein the application program, when executed by the processor, further causes the electronic device to:
when responding to the N-th shooting instruction and generating the N-th photo based on the N-th set of captured images:
obtain a first quantity of captured images based on the N-th shooting instruction, the first quantity of captured images being acquired by the image acquisition apparatus; and
generate the N-th photo based on a target quantity of captured images being obtained and a target image processing algorithm, the target quantity being determined by a target parameter of the N-th shooting instruction and being greater than or equal to the first quantity; and
when responding to the (N+1)-th shooting instruction and generating the (N+1)-th photo based on the (N+1)-th set of captured images:
obtain a second quantity of captured images based on the target parameter of the (N+1)-th shooting instruction, the second quantity of captured images being acquired by the image acquisition apparatus, and the target quantity being greater than the second quantity; and
generate the (N+1)-th photo based on a target quantity of captured images being captured and the target image processing algorithm.

18. The storage medium according to claim 17, wherein the application program, when executed by the processor, further causes the electronic device to, when obtaining the first quantity of captured images based on the N-th shooting instruction:
in response to the N-th shooting instruction representing a first shooting instruction, determine the first quantity as the target quantity.
